(19) United States
(12) Patent Application Publication
(10) Pub. No.: US 2011/0210279 A1
(43) Pub. Date: Sep. 1, 2011

(54) Gas Valves for Pneumatic Devices

(75) Inventor: Robert C. Popke, Hawthorn Woods, IL (US)

(73) Assignee: MIDWEST SEALING PRODUCTS, INC., Buffalo Grove, IL (US)

(21) Appl. No.: 12/713,716

(22) Filed: Feb. 26, 2010

(51) Int. Cl. F16K 27/00

(52) U.S. Cl. 251/366

(57) ABSTRACT

An improved valve assembly for routing gas, such as a high-pressure sour gas from an oil well, into a pneumatic device is disclosed. The pneumatic device may be in operational communication with an injection pump adapted to inject chemicals, such as methanol, back into the oil well. The valve assembly may be operated by a gas cylinder to direct the high-pressure gas from a pressure port into the intake pneumatic device and route the exhaust gas from the pneumatic device to an exhaust port. The valve assembly includes a valve element slidably disposed in a valve housing, wherein the valve element includes a frustoconical sealing surface that is complementary to a frustoconical valve seat provided on the interior surface of the valve housing.

### BACKGROUND

1. Technical Field:

An improved valve assembly for routing gas, such as a high-pressure sour gas from an oil well, into a pneumatic device is disclosed. The pneumatic device may be in operational communication with an injection pump adapted to inject chemicals, such as methanol, back into the oil well. The valve assembly may be operated by a gas cylinder to direct the high-pressure sour gas from a pressure port into the pneumatic device and route the exhaust gas from the pneumatic device to an exhaust port. The valve assembly includes a valve element slidably disposed in a valve housing, wherein the valve element includes a frustoconical sealing surface that is complementary to a frustoconical valve seat provided on the interior surface of the valve housing.

2. Description of the Related Art:

Harnessing the enormous kinetic energy potential of the high pressure multiphase flow of gas released from an oil or natural gas well has been well known in the art. One example is the use of the sour gas, i.e. natural gas with high hydrogen sulfide contents, released from the oil well to periodically or continuously inject chemicals back into the oil well. Methanol, for example, may be injected to prevent water present in the natural gas from freezing. Other chemicals may include treatment fluid that contain a corrosion or hydrate inhibitor, a viscosity reducing agent, a chemical agent to prevent deposition of sulfur, asphaltenes or waxes, or a foam generating agent which inhibits accumulation of condensed water and/or condensates downhole in the well.

Such chemicals are injected by means of pumps which overcome the pressure of the compressed gas to force the liquid into the pipeline. These injection pumps are often powered by pneumatic devices, particularly in remote locations. In some situations, the compressed gas flowing in the pipeline is used to drive the pump, but usually only after it has been regulated to a pressure suitable for the injection pump. Alternatively, the high pressure gas may need to be routed to a pneumatic device to accumulate enough energy to drive the pump. The exhaust gas from the pneumatic devices comes out at a much lower pressure than the gas released from the well so that it can be easily disposed by simply burning it off.

One known pneumatic device uses a single-acting piston that reciprocates within an open-ended cylinder inside a pressure vessel, where the interior of the pressure vessel is in fluid communication with the area of lower pressure, such that the bottom end of the piston is always exposed to the lower pressure. A switching valve allows gas from the area of higher pressure to flow into the chamber at the closed end cylinder, thus inducing a pressure differential between the two ends of the piston, causing the piston to move in a downward or power stroke. A linkage mechanism is provided for transferring the energy from the power stroke to an oscillatingly rotating output shaft, which is then connected to an injection pump or other type of equipment to be driven.

At or near the end of the downward stroke, the switching valve opens the piston chamber to the interior of the pressure vessel and closes off flow of higher pressure gas into the chamber, thus equalizing the pressure on each end of the piston. Biasing means such as a spring then move the piston back to the top of the piston chamber, thus exhausting the gas in the piston chamber into the pressure vessel and, effectively, into the area of lower pressure within the pressurized gas system. At or near the end of this exhaust stroke, the switching valve closes off the piston chamber from the interior of the pressure vessel and opens the chamber once again to the flow of gas from the area of higher pressure, thus preparing the apparatus for the next downward power stroke.

However, because this pneumatic device uses a single-acting piston, it produces power only on half of the piston strokes. As a result, the mechanical efficiency of this device is relatively low. An additional drawback of the single-acting piston device is that the spring or other biasing means that returns the piston to the top of the cylinder after each power stroke must be compressed during each power stroke, thus consuming part of the energy inherent in the pressure differential and thereby reducing the power output of the apparatus.

Accordingly, a gas-driven reciprocating drive apparatus that uses a double-acting piston within a closed cylinder and powered by a pressurized gas system such as a gas pipeline has been developed. In operation, a switching valve directs gas from areas of higher and lower pressure to opposite sides of the piston. The pressure differential between the two ends of the double-acting piston causes the piston to move toward a first end of the cylinder, simultaneously exhausting the gas in the first end of the cylinder back into the pressurized gas system. A drive link connected to the piston is used to transfer the power generated by the movement of the piston to an injection pump. At or near the end of each piston stroke, the switching valve reverses the connections to the areas of higher and lower pressure in the pressurized gas system, thus inducing a pressure differential that causes the piston to move in the direction opposite to the previous stroke and thereby exhausting the gas in the second end of the cylinder back into the pressurized gas system.

The switching valve includes an elongated valve housing defining a center bore and a center shaft disposed within, but does not engage the cylindrical surface of, the center bore. Two air operated pistons are provided on the ends of the center shaft to move the shaft in reciprocating manner. Two spaced-apart annular sealing elements are circumferentially disposed between the connecting shaft and the cylindrical surface of the center bore, segmenting the space therebetween into three fluid channels. The center portion of the valve housing also includes a plurality of gas inlet and outlet ports that can be interconnected with one another in various configurations through the fluid channels depending on the position of the connecting shaft so that the higher and lower pressured gases can be routed in and out of the cylinder in a reciprocating manner.

One significant drawback of the switching valve is the susceptibility of the annular sealing elements to wear and deterioration. In order to maintain a pressure differential between the ends of the cylinder, the double-acting piston requires relatively tight circumferential seals to prevent fluid communication among the fluid channels. The tight seal induces proportionately higher friction forces against the movement of the center shaft. These friction forces must be overcome in order for the piston to move, and the power required to do this reduces the available power output from the apparatus. Moreover, if the friction forces become too high, the piston may be susceptible to seizing or stalling. In addition, the high friction forces promote wear on the seals, thus making seal replacement necessary more often than would be the case in absence of high differential pressures across the seals.

Further, the elongated housing and shaft design not only make the valve bulky, but also require the disassembly of the entire valve if one of the sealing element seizes or malfunctions.

Hence, there is a need for a valve assembly with a sealing element less susceptible to friction-induced power output losses and less susceptible to wear and deterioration. Moreover, there is a need for a valve assembly that can route a higher pressured gas into, and a lower pressured gas out of, a pneumatic device through alternating ends thereof. Finally, there is a need for a valve assembly with a more robust and compact design that is easy to operate and maintain,

### SUMMARY OF THE DISCLOSURE

This disclosure is generally directed toward a valve assembly that may be used to supply a high-pressure gas to a reciprocating pneumatic device and to vent the exhaust gas from the pneumatic device to a low pressure environment. In particular, the disclosed valve assembly uses a valve element that may be less susceptible to friction-induced power output losses and less susceptible to wear and deterioration.

In one embodiment, the valve element may include a distal head portion comprising a first cylindrical sidewall and a sealing member. The sealing member may include a frustoconical sealing surface with a concentric annular groove thereon and an O-ring gasket disposed in the annular groove, wherein the proximal end of the frustoconical sealing surface merges with the distal end of the first cylindrical sidewall.

The valve element may further include a proximal tail portion comprising a second cylindrical sidewall disposed at the distal end of the tail portion. The first and second cylindrical sidewalls may be coaxial and have identical outer diameters. A neck portion interconnects the head and tail portions, wherein the neck portion includes a third cylindrical sidewall with an outer diameter smaller than those of the first and second cylindrical sidewalls.

The distal end of the sealing member may be connected to a fourth cylindrical sidewall that is coaxial with the first cylindrical sidewall and having an outer diameter smaller than that of the first cylindrical sidewall.

The annular groove may be disposed close to the base of the frustoconical sealing surface. Alternatively, the annular groove may be provided close to the top edge of the frustoconical sealing surface.

The frustoconical sealing surface and the first cylindrical sidewall are merged to each other at an angle α of from about 120° to about 150°. In one embodiment, the merging angle α is about 135°. As used herein, “about” when used to modify a valve means plus or minus ten percent of that value.

The valve element may also include a center bore extending through the distal head portion, the center bore being coaxial with the first cylindrical sidewall. The center bore may also extend throughout the valve element. Further, the center bore may include sections of different diameters interconnected through stepped transition sections.

The proximal end of the tail portion of the disclosed valve element may include an annular flange coaxial with the first and second cylindrical sidewalls. The annular flange may further include a recess area adapted to be connected to an air cylinder connecting shaft.

The tail portion of the disclosed valve element may further include a fifth cylindrical sidewall coaxially disposed between the second cylindrical sidewall and the annular flange.

In another embodiment, the disclosed valve assembly may include a valve housing defining a stepped center bore terminating into a distal opening connected to an exhaust port. The stepped center bore may include a frustoconical valve seat. The valve housing may further include a transverse side opening.

The valve assembly further includes a valve element slidably disposed in the valve housing. The valve element includes a distal head portion connected to a proximal tail portion through a neck portion. The head portion includes a frustoconical sealing surface with a concentric annular groove thereon and an O-ring gasket disposed in the annular groove. The frustoconical sealing surface may be complementary to the frustoconical valve seat of the valve housing.

In operation, the valve element and the center bore of the valve housing define an annular space in fluid communication with the side opening when the O-ring gasket seals against the valve seat. Moreover, the side opening of the valve housing may be in fluid communication with the exhaust port through the distal opening when the O-ring gasket does not seal against the valve seat.

In another embodiment, the disclosed valve assembly may include a valve housing defining a stepped center bore terminating into a distal opening connected to a pressure port. The stepped center bore may include a frustoconical valve seat. The valve housing may further include first and second transverse side openings.

The valve assembly further includes a valve element slidably disposed in the valve housing. The valve element includes a distal head portion connected to a proximal tail portion through a neck portion. The head portion includes a frustoconical sealing surface with a concentric annular groove thereon and an O-ring gasket disposed in the annular groove. The frustoconical sealing surface may be complementary to the frustoconical valve seat of the valve housing.

In operation, the valve element and the center bore of the valve housing define an annular space through which the first and second side openings of the valve housing may be in fluid communication with each other when the O-ring gasket seals against the valve seat. Further, the first and second openings of the valve housing may be in fluid communication with the pressure port through the distal opening when the O-ring gasket does not seal against the valve seat.

In a refinement, the first side opening is adapted to be in fluid communication with a pneumatic device. The pneumatic device may be connected to a fluid injection pump.

In yet another embodiment, the disclosed valve assembly may include first and second valve housings each defining a stepped center bore terminating into a distal opening. The distal openings of the first and second housings may be connected to each other through a first channel, while the first channel may be connected to a pressure port.

The valve assembly may also include third and fourth valve housings each defining a stepped center bore terminating into a distal opening. The distal openings of the third and fourth housings may be connected to each other through a second channel, wherein the second channel may be connected to an exhaust port. In this embodiment, the stepped center bores of the first, second, third and fourth housings may each include a frustoconical valve seat.

The valve assembly may also include a valve element slidably disposed in each of the first, second, third, and fourth valve housings. The valve element may include a distal head portion connected to a proximal tail portion through a neck portion. The head portion includes a frustoconical sealing surface with a concentric annular groove thereon and an O-ring gasket disposed in the annular groove, wherein the frustoconical sealing surface may be complementary to the frustoconical valve seat of each housing.

Further, the center bores of the first and third valve housings are connected to each other through a third channel, and the second and fourth valve housings are connected to each through a fourth channel. In a refinement, the first, second, third, and fourth channels may be coplanar.

Other advantages and features will be apparent from the following detailed description when read in conjunction with the attached drawings. It will also be noted here and elsewhere that the valve elements and assemblies disclosed herein may be suitably modified to be used in a wide variety of industrial operations by one of ordinary skill in the art without undue experimentation.

### BRIEF DESCRIPTION OF THE DRAWINGS

For a more complete understanding of the disclosed janitorial container, reference should be made to the embodiments illustrated in greater detail in the accompanying drawings, wherein:

FIG. 1 is a front perspective view one embodiment of the disclosed valve assembly in accordance with this disclosure;

FIG. 2 is a side perspective view of the embodiment of the disclosed valve assembly illustrated in FIG. 1;

FIG. 3 is a sectional view of the embodiment of the disclosed valve assembly illustrated in FIGS. 1-2, taken along line 3-3′, particularly illustrating the valve elements in a first position;

FIG. 4 is a sectional view of the embodiment of the disclosed valve assembly illustrated in FIGS. 1-2, taken along line 3-3′, particularly illustrating the valve elements in a second position;

FIG. 5 is a side perspective view of one embodiment of the disclosed valve element in accordance with this disclosure; and

FIG. 6 is a sectional view of the embodiment of the disclosed valve element illustrated in FIG. 5, taken along line 6-6′;

It should be understood that the drawings are not necessarily to scale and that the disclosed embodiments are sometimes illustrated diagrammatically and in partial views. In certain instances, details which are not necessary for an understanding of the disclosed valve element or assembly or which render other details difficult to perceive may have been omitted. It should be understood, of course, that this disclosure is not limited to the particular embodiments illustrated herein.

### DETAILED DESCRIPTION OF THE PREFERRED EMBODIMENTS

This disclosure is generally directed toward a valve assembly that may be used to supply a high pressured gas to a reciprocating pneumatic device and to vent the exhaust gas from the pneumatic device to a low pressure environment. In particular, the disclosed valve assembly uses a valve element that may be less susceptible to friction-induced power output losses and less susceptible to wear and deterioration.

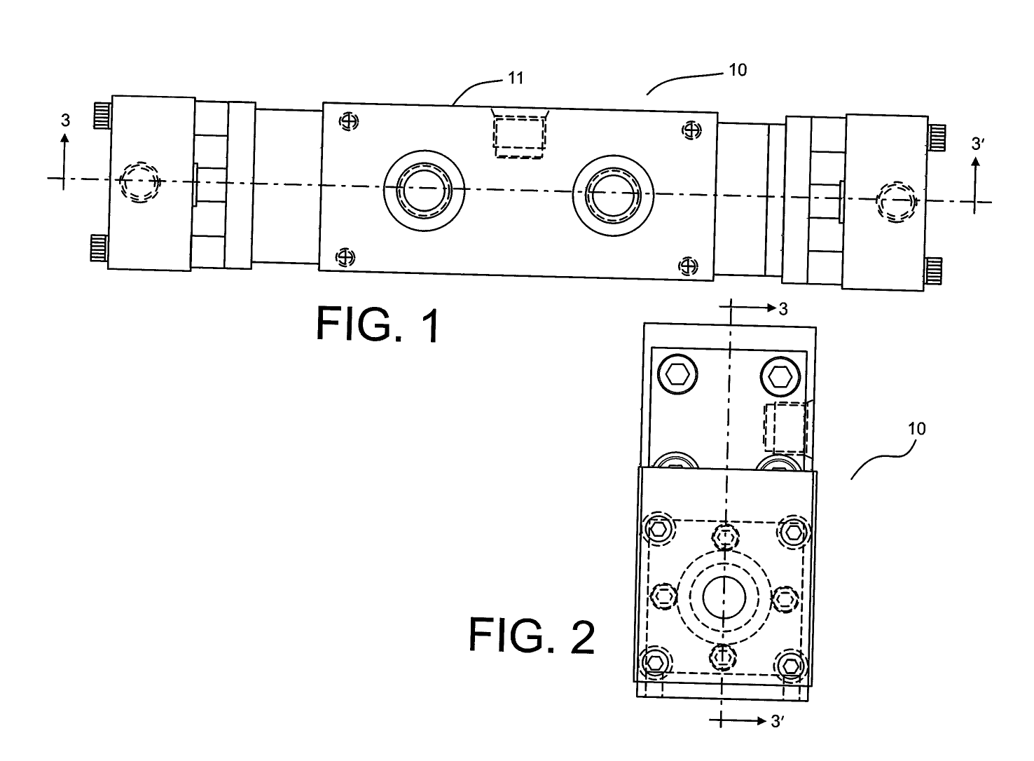

One embodiment of the disclosed valve assembly is illustrated in FIGS. 1-3. The valve assembly 10 may include a base 11 having a plurality of valve housing cavities (21, 22, 23, 24) interconnected with one another through a plurality of fluid channels (31, 32, 33, 34) formed within the base 11.

As exemplified in this embodiment, a first valve housing cavity 21 may be connected to a second valve housing cavity 22 through a first fluid channel 31, whereas a third valve housing cavity 23 may be connected to a fourth valve housing cavity 24 through a second fluid channel 32. The first and second fluid channels may be parallel to each other. Likewise, the first valve housing cavity 21 may be connected to the third valve housing cavity 23 through a third fluid channel 33, whereas the second valve housing cavity 22 may be connected to the fourth valve housing cavity 24 through a fourth fluid channel 34. The third and fourth fluid channels may be parallel to each other. Additionally, the fluid channels (21, 22, 23, 24) may be coplanar with each other. Furthermore, the first and second fluid channels (21, 22) may be perpendicular to the third and fourth fluid channels (23, 24), respectively.

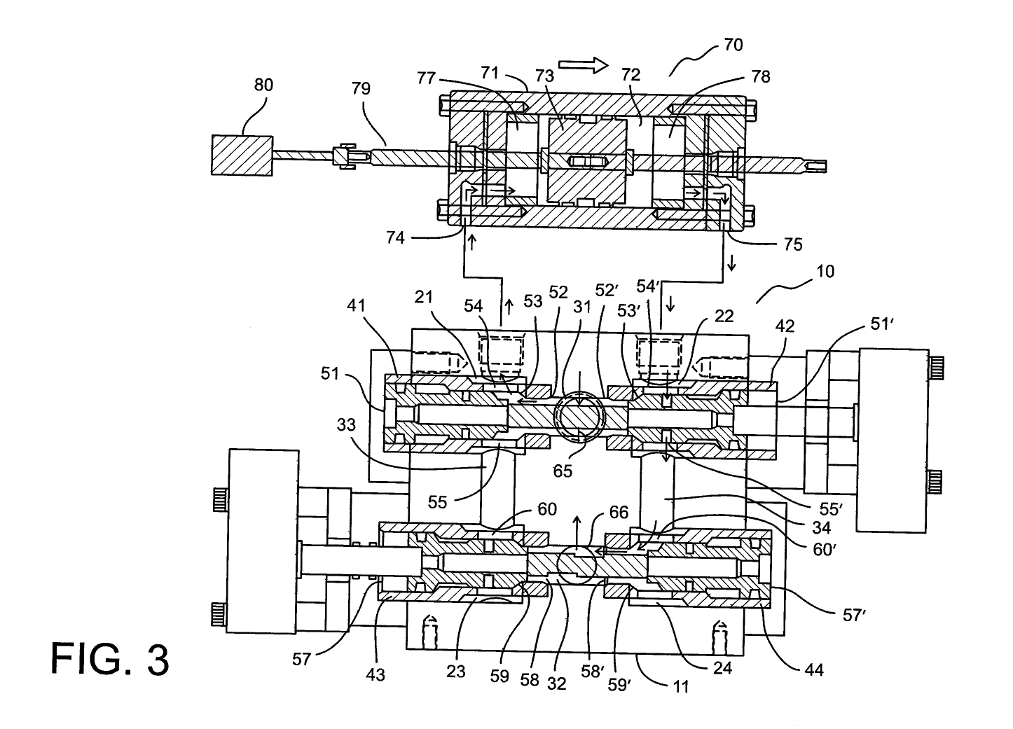

The valve assembly 10 may further include a plurality of valve housings (41, 42, 43, 44) each inserted into one of the valve housing cavities (21, 22, 23, 24). Although the base 11 and the valve housings (41, 42, 43, 44) are shown in FIG. 3 to be separate components of the valve assembly 10, it is to be understood that they can be integrated together to form a single unit and the configuration illustrated in FIG. 3 should not be interpreted as limiting the scope of this disclosure.

The valve housings (41, 42), respectively inserted into the valve housing cavities (21, 22), may have a general shape of a hollow cylinder defining a stepped center bore (51, 51′) terminating into a distal opening (52, 52′). The center bores (51, 51′) may each include a frustoconical valve seat (53, 53′). The distal openings (52, 52′) of the first and second valve housings (41, 42) may be connected to each other through the first fluid channel 31, which in turn may be connected to a pressure port 65. The pressure port 65 may be connected to a high pressure gas source, such as high pressure sour gas in an oil well.

Further, the valve housings (41, 42) may each include a first side opening (54, 54′) and a second side opening (55, 55′). The second side openings (55, 55′) of the valve housings (41, 42) may be connected to the third and fourth fluid channels (33, 34), respectively. The first side openings (54, 54′) may be connected to a reciprocating pneumatic device 70.

As exemplified in FIG. 3, the pneumatic device 70 may include a cylindrical housing 71 defining a piston chamber 72, in which a piston 73 is slidably disposed. The housing 71 may further include a first fluid port 74 in communication with a first end 77 of the piston chamber 72, as well as a second fluid port 75 in communication with a second end 78 of the piston chamber 72. The piston 73 may be in operational communication with a chemical injection pump 80, e.g. through a connecting shaft 79.

On the other hand, the third and fourth valve housings (43, 44), respectively inserted into the valve housing cavities (23, 24), may also have a general shape of a hollow cylinder defining a stepped center bore (57, 57′) terminating into a distal opening (58, 58′). The center bores (57, 57′) may each include a frustoconical valve seat (59, 59′). The distal openings (58, 58′) of the third and fourth valve housings (43, 44) may be connected to each other through the second fluid channel 32, which in turn may be connected to an exhaust port 66. The exhaust port 66 may be connected to a low pressure gas source, such as an exhaust pipe terminating into a burner to burn off the dirty natural gas before it is released into the air. Further, the valve housings (43, 44) may each include a third side opening (60, 60′), which may be connected to the second side openings (55, 55′) of the valve housings (41, 42) through the third and fourth fluid channels (33, 34), respectively.

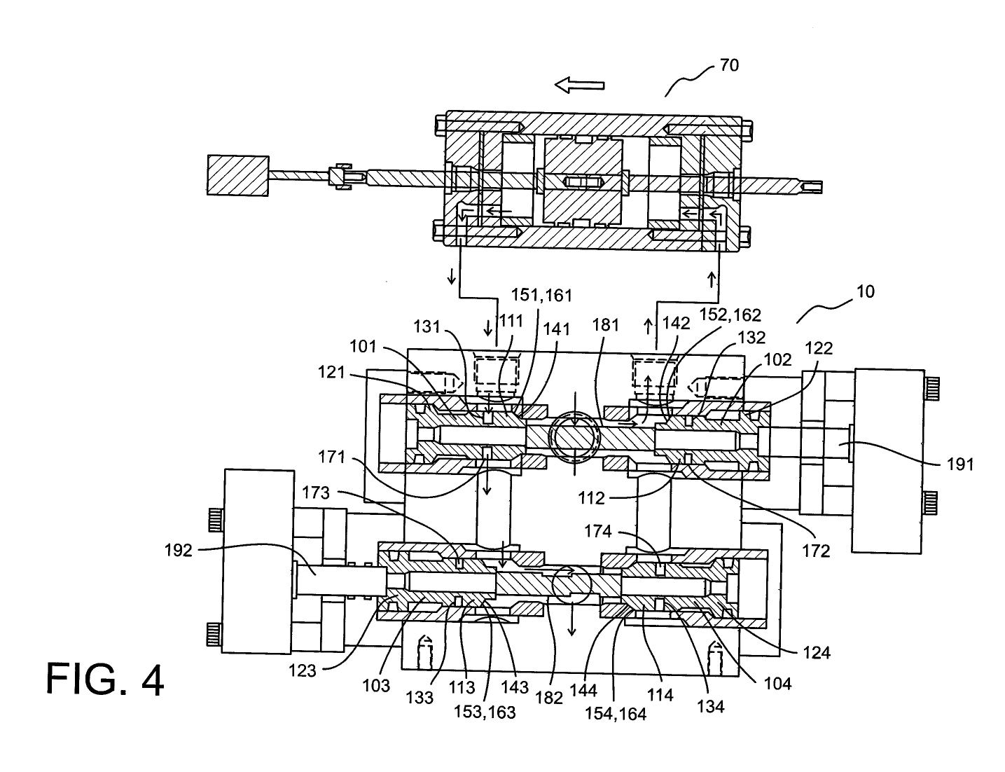

In order to properly route the sour gas in and out of the pneumatic device 70, the valve assembly 10 further includes a plurality of valve elements (101, 102, 103, 104) each slidably disposed in one of the valve housings (41, 42, 43, 44). As generally illustrated in FIGS. 3-4, the valve elements (101, 102, 103, 104) may each include a distal head portion (111, 112, 113, 114) connected to a proximal tail portion (121, 122, 123, 124) through a neck portion (131, 132, 133, 134). The head portions (111, 112, 113, 114) may each include a frustoconical sealing surface (141, 142, 143, 144) with a concentric annular groove (151, 152, 153, 154) thereon and an O-ring gasket (161, 162, 163, 164) disposed in the annular groove. The frustoconical sealing surfaces (141, 142, 143, 144) may be complementary to the frustoconical valve seats (53, 53′, 59, 59′) of the valve housings (41, 42, 43, 44), respectively.

As illustrated in FIGS. 3-4, the valve elements (101, 102, 103, 104) and the center bores (51, 51′, 57, 57′) of the valve housings (41, 42, 43, 44) define a plurality of annular spaces (171, 172, 173, 174). With particular reference to the valve elements 103 and 104, the annular spaces (173, 174) may be in fluid communication with the third side openings (60, 60′) when the 0-ring gaskets (163, 164) seal against the valve seats (59, 59′). Moreover, the third side openings (60, 60′) of the valve housings (43, 44) may be in fluid communication with the exhaust port 66 when the O-ring gaskets (163, 164) do not seal against the valve seats (59, 59′).

With respect to the valve elements 101 and 102, the first side openings (54, 54′) and the second side openings (55, 55′) of the valve housings (41, 42) may be in fluid communication with each other through the annular spaces (171, 172) when the O-ring gaskets (161, 162) seal against the valve seats (53, 53′). On the other hand, when the O-ring gaskets (161, 162) do not seal against the valve seats (53, 53′), the first side opening (54, 54′) and the second side opening (55, 55′) may be in fluid communication with the pressure port 65.

The distal head portions (111, 112) of the first and second valve elements (101, 102) may be interconnected with each other through a first shaft 181. The sliding movement of the valve elements (101, 102) may be actuated by a first air cylinder shaft 191 connected to the proximal tail portion 122 of the second valve element 102. As a result, the valve elements (101, 102) may be slidable from a first position, in which the gasket 161 does not seal against the valve seat 53 and the gasket 162 seals against the valve seat 53′ as illustrated in FIG. 3, to a second position, in which the gasket 161 seals against the valve seat 53 and the gasket 162 does not seal against the valve seat 53′ as illustrated in FIG. 4.

Similarly, the distal head portions (113, 114) of the third and fourth valve elements (103, 104) may be interconnected with each other through a second shaft 182. The sliding movement of the valve elements (103, 104) may be actuated by a second air cylinder shaft 192 connected to the proximal tail portion 123 of the third valve element 103. As a result, the valve elements (103, 104) may be slidable from a first position, in which the gasket 164 does not seal against the valve seat 59′ and the gasket 163 seals against the valve seat 59 as illustrated in FIG. 3, to a second position, in which the gasket 164 seals against the valve seat 59′ and the gasket 163 does not seal against the valve seat 59 as illustrated in FIG. 4.

In operation, both first and second air cylinder shafts (191, 192) may operate in a reciprocating manner so that the sliding movement of the first and second valve elements (101, 102) is in opposite direction to that of the third and fourth valve elements (103, 104), As a result, the first position of the first and second valve elements coincides with the first position of the third and fourth valve elements as illustrated in FIG. 3, and the second position of the first and second valve elements coincides with the second position of the third and fourth valve element as illustrated in FIG. 4.

In FIG. 3, the high pressure sour gas enters the valve assembly 10 through the pressure port 65. Because the gasket 162 is sealed against the valve seat 53′ and the gasket 161 is not sealed against the valve seat 53, the gas is routed into the first valve housing 41 through the distal opening 52. The gas cannot exit the valve assembly 10 through the exhaust port 66 because the gasket 163 is sealed against the valve seat 59. Hence, the gas may only exit the valve assembly 10 through the first side opening 54 and enters the piston chamber 72 of the pneumatic device 70 through the first fluid port 74, causing the piston 73 to move towards the second end 78 of the piston chamber 72. Accordingly, the exhaust gas enters the second valve housing 42 through the second fluid port 75 and the first side opening 54′. The exhaust gas cannot exit the second valve housing 42 through the distal opening 52′ because the gasket 162 is sealed against the valve seat 53′. However, because the gasket 164 is not sealed against the valve seat 59′, the exhaust gas may exit the valve assembly 10 through the annular space 172, the fourth fluid channel 34, the distal opening 58′, and the exhaust port 66.

As the piston 73 approaches the second end 78 of the piston chamber 72, the first and second air cylinder shafts (191, 192) reverse their movement, causing the valve elements (101, 102, 103, 104) to assume the second position as illustrated in FIG. 4, in which the high pressure sour gas continues to enter the valve assembly 10 through the pressure port 65. Because the gasket 161 is sealed against the valve seat 53 and the gasket 162 is not sealed against the valve seat 53′, the gas is routed into the second valve housing 42 through the distal opening 52′. The gas cannot exit the valve assembly 10 through the exhaust port 66 because the gasket 164 is now sealed against the valve seat 59′. Hence, the gas may only exit the valve assembly 10 through the first side opening 54′ of the second valve housing 42 and enters the piston chamber 72 of the pneumatic device 70 through the second fluid port 75, causing the piston 73 to move back towards the first end 77 of the piston chamber 72. The exhaust gas then enters the first valve housing 41 through the first fluid port 74 and the first side opening 54 of the first valve housing 42.

The exhaust gas may not exit the first valve housing 41 through the distal opening 52 because the gasket 161 is now sealed against the valve seat 53. However, because the gasket 163 is not sealed against the valve seat 59, the exhaust gas may exit the valve assembly 10 through the annular space 171, the third fluid channel 33, the distal opening 58, and the exhaust port 66. As the piston 73 approaches the first end 77 of the piston chamber 72, the first and second air cylinders (191, 192) reverse their movement again, repeating the movement of the piston 72 described above. Thus, the pressure potential of the sour gas is conveniently converted to the continuous and reciprocating movement of the piston 72 that drives the injection pump 80 to inject chemicals back into the oil well.

Further, because the O-ring gaskets (161, 162, 163, 164) are provided on the frustoconical surfaces of the valve elements (101, 102, 103, 104), rather than circumferentially along the cylindrical surfaces of the valve elements, the gaskets do not cause any frictional resistance to the sliding movement of the valve elements, thus avoiding the use of air cylinders with a larger actuation force to operate the valve elements. Moreover, the absence of frictional engagement of the gasket with the valve housing reduces the wear and tear of the gasket and the operation cost of the valve assembly.

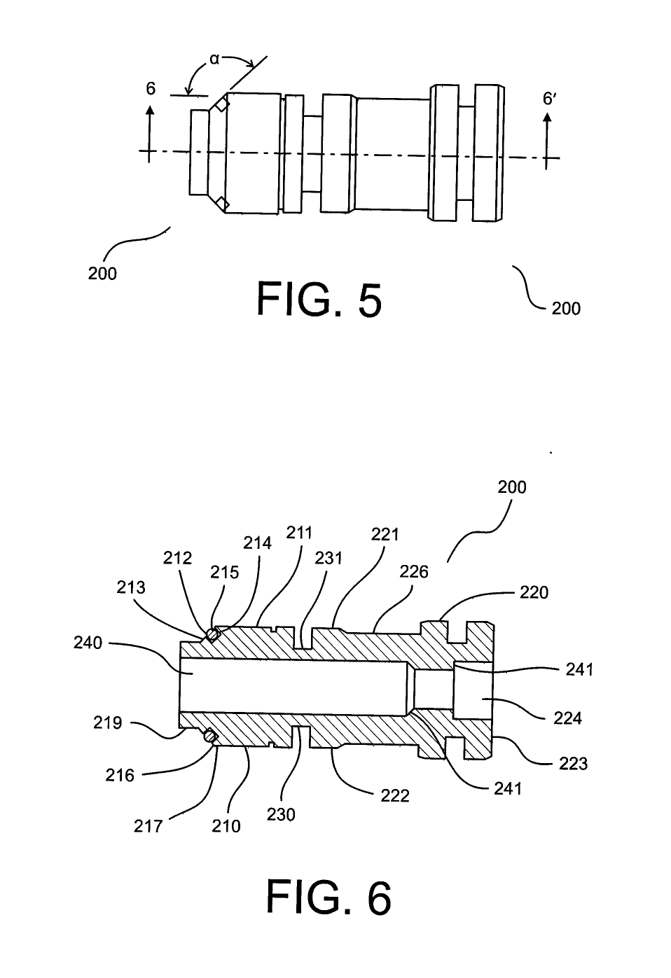

A more detailed description of the valve element used in the disclosed valve assembly is provided in FIGS. 5-6. In one embodiment, the valve element 200 may include a distal head portion 210 having a first cylindrical sidewall 211 and a sealing member 212. The sealing member 212 may include a frustoconical sealing surface 213 with a concentric annular groove 214 thereon and an 0-ring gasket 215 disposed in the annular groove 214. The proximal end 216 of the frustoconical sealing surface 213 may merge with the distal end 217 of the first cylindrical sidewall 211.

The valve element 200 may further include a proximal tail portion 220 having a second cylindrical sidewall 221 disposed at the distal end 222 of the tail portion 220. The first and second cylindrical sidewalls (211, 221) may be coaxial and may have identical outer diameters. The valve element 200 may also include a neck portion 230 that interconnects the head and tail portions (210, 220). The neck portion 230 may include a third cylindrical sidewall 231 with an outer diameter smaller than those of the first and second cylindrical sidewalls (211, 221).

The distal end 218 of the sealing member 212 may be connected to a fourth cylindrical sidewall 219 that is coaxial with the first cylindrical sidewall 211 and having an outer diameter smaller than that of the first cylindrical sidewall 211.

The annular groove 214 may be disposed close to the base of the frustoconical sealing surface 213. Alternatively, the annular groove 214 may be provided at the middle or close to the top edge of the frustoconical sealing surface 213. As illustrated in FIG. 5, the frustoconical sealing surface 213 and the first cylindrical sidewall 211 may be merged to each other at an angle α of from about 120° to about 150°. In one embodiment, the merging angle α is about 135°.

The valve element 200 may also include a center bore 240 extending at least through the distal head portion 210, wherein the center bore 240 may be coaxial with the first cylindrical sidewall 211. The center bore 240 may also extend throughout the entire valve element 200. Further, the center bore 200 may include sections of different diameters interconnected through stepped transitions 241.

The proximal tail portion 220 of the valve element 200 may further include an annular flange 223 coaxial with the first and second cylindrical sidewalls (211, 221). The annular flange 223 may further include a recess area 224 adapted to be connected to an air cylinder shaft. The proximal tail portion 220 of the valve element 200 may also include a fifth cylindrical sidewall 226 coaxially disposed between the second cylindrical sidewall 221 and the annular flange 223.

Numerous modifications and variations of the present invention are possible in light of the above disclosure. It is therefore to be understood that, within the scope of the appended claims, the invention may be practiced otherwise than as specifically described herein. While only certain embodiments have been set forth, alternatives and modifications will be apparent from the above description to those skilled in the art. These and other alternatives are considered equivalents and within the spirit and scope of this disclosure and the appended claims.

What is claimed is:

1. A valve element, comprising:
a distal head portion comprising a first cylindrical sidewall and a sealing member, the sealing member comprising a frustoconical sealing surface with an concentric annular groove thereon and an O-ring gasket disposed in the annular groove, the proximal end of the frustoconical sealing surface merging with the distal end of the first cylindrical sidewall;
a proximal tail portion comprising a second cylindrical sidewall disposed at the distal end of the tail portion, the first and second cylindrical sidewalls being coaxial and having identical outer diameters; and
a neck portion interconnecting the head and tail portions, the neck portion comprising a third cylindrical sidewall with an outer diameter smaller than those of the first and second cylindrical sidewalls.

2. The valve element of claim 1, wherein the distal end of the sealing member is connected to a fourth cylindrical sidewall that is coaxial with the first cylindrical sidewall and has an outer diameter smaller than that of the first cylindrical sidewall.

3. The valve element of claim 1, wherein the annular groove is disposed close to the base of the frustoconical sealing surface.

4. The valve element of claim 1, wherein the frustoconical sealing surface and the first cylindrical sidewall are merged to each other at an angle α of from about 120° to about 150°.

5. The valve element of claim 1, further comprising a center bore extending through the distal head portion, the center bore being coaxial with the first cylindrical sidewall.

6. The valve element of claim 1, wherein the proximal end of the tail portion comprises an annular flange coaxial with the first and second cylindrical sidewalls.

7. The valve element of claim 6, wherein tail portion further comprises a fifth cylindrical sidewall coaxially disposed between the second cylindrical sidewall and the annular flange.

8. A valve assembly, comprising:
a valve housing defining a stepped center bore terminating into a distal opening, the stepped center bore comprising a frustoconical valve seat, the valve housing further comprising a transverse side opening; and
a valve element slidably disposed in the valve housing, the valve element comprising a distal head portion connected to a proximal tail portion through a neck portion, the head portion comprising a frustoconical sealing surface with an concentric annular groove thereon and an O-ring gasket disposed in the annular groove, the frustoconical sealing surface being complementary to the frustoconical valve seat, the valve element and the center bore of the valve housing defining an annular space in fluid communication with the side opening when the O-ring gasket seals against the valve seat.

9. The valve assembly of claim 8, wherein the side opening of the valve housing is in fluid communication with the distal opening when the O-ring gasket does not seal against the valve seat.

10. The valve assembly of claim 8, wherein the annular groove is disposed close to the base of the frustoconical sealing surface.

11. The valve assembly of claim 8, wherein the proximal end of the tail portion further comprises an annular flange coaxial with the annular groove.

12. A valve assembly, comprising:
a valve housing defining a stepped center bore terminating into a distal opening, the stepped center bore comprising a frustoconical valve seat, the valve housing further comprising first and second transverse side openings; and
a valve element slidably disposed in the valve housing, the valve element comprising a distal head portion connected to a proximal tail portion through a neck portion, the head portion comprising a frustoconical sealing surface with a concentric annular groove thereon and an O-ring gasket disposed in the annular groove, the frustoconical sealing surface being complementary to the frustoconical valve seat, the valve element and the center bore of the valve housing defining an annular space through which the first and second side openings of the valve housing are in fluid communication with each other when the O-ring gasket seals against the valve seat.

13. The valve assembly of claim 12, wherein the first and second openings of the valve housing are in fluid communication with the distal opening when the O-ring gasket does not seal against the valve seat.

14. The valve assembly of claim 12, wherein the first side opening is adapted to be in fluid communication with a pneumatic device.

15. The valve assembly of claim 14, wherein the pneumatic device is connected to a fluid injection pump.

16. The valve assembly of claim 12, wherein the annular groove is disposed close to the base of the frustoconical sealing surface.

17. The valve assembly of claim 12, wherein the proximal end of the tail portion comprises an annular flange coaxial with the annular groove.

18. A valve assembly, comprising:
first and second valve housings each defining a stepped center bore terminating into a distal opening, the distal openings of the first and second housings being connected to each other through a first channel;
third and fourth valve housings each defining a stepped center bore terminating into a distal opening, the distal openings of the third and fourth valve housings being connected to each other through a second channel, the stepped center bores of the first, second, third and fourth housings each comprising a frustoconical valve seat; and
a valve element slidably disposed in each of the first, second, third, and fourth valve housings, the valve element comprising a distal head portion connected to a proximal tail portion through a neck portion, the head portion comprising a frustoconical sealing surface with an concentric annular groove thereon and an O-ring gasket disposed in the annular groove, the frustoconical sealing surface being complementary to the frustoconical valve seat of each housing, the center bores of the first and third valve housings being connected to each other through a third channel and the center bores of the second and fourth valve housings are connected to each through a fourth channel, the first, second, third, and fourth channels being coplanar.

19. The valve assembly of claim 18, wherein the distal head portions of the valve elements disposed in the first and second housings are connected to each other through a first shaft and wherein the distal head portions of the valve elements disposed in the third and fourth housings are connected to each other through a second shaft.

20. The valve assembly of claim 19, wherein the first and second housings are connected to a pneumatic device.
